(19) United States
(12) Patent Application Publication
(10) Pub. No.: US 2007/0095210 A1
(43) Pub. Date: May 3, 2007

(54) Direct injection and vaporization of ammonia

(75) Inventor: Edwin L. West, (US)

Correspondence Address: TROUTMAN SANDERS LLP, 600 PEACHTREE STREET , NE, ATLANTA, GA, 30308, US

(73) Assignee: Southern Company Services, Inc., Birmingham, AL (US)

(21) Appl. No.: 11/591,135

(22) Filed: Nov. 1, 2006

Related U.S. Application Data
(60) Provisional application No. 60/733,134, filed on Nov. 3, 2005.

(51) Int. Cl. B01D 53/14

(52) U.S. Cl. 95/149

(57) ABSTRACT

The present invention provides a system for regulating the flow of a two-phase composition containing a liquid and a vapor, as well as for stable-delivery of the liquid, vapor, and/or two-phase composition to a process/location, which includes a feed conduit, a separation chamber, and a flow control means, where (1) the separation chamber contains an inlet, a liquid outlet, and a vapor outlet; (2) the feed conduit is operatively connected with the inlet; and (3) the flow control means is operatively connected with the liquid outlet or the vapor outlet and regulates the flow of the liquid through the liquid outlet or the flow of the vapor through the vapor outlet. In addition, the system of present invention may further include various feedback control means for regulating the flow of liquid and vapor, and a storage means operatively connected with the feed conduit, where the storage means may contain a heating means for regulating the internal pressure of the storage means and/or the temperature/pressure of the two-phase composition or the liquid. Also provided are methods of using the system.

### RELATED APPLICATION

This application claims the benefit of U.S. Provisional Patent Application No. 60/733,134, filed Nov. 3, 2005, which is herein incorporated by reference in its entirety.

### FIELD OF THE INVENTION

The present invention relates generally to the controlled-delivery of compositions containing both liquid and vapor. In addition, the present invention relates to cleaning of the waste gases resulting from fossil fuel combustion, and more specifically to the direct injection and vaporization of ammonia (DIVA) for controlling the flow of ammonia reagent to a Selective Catalytic Reduction (SCR) system.

### BACKGROUND OF THE INVENTION

There are many problems related to the measurement and control of the flow of a two-phase mixture of liquid and vapor. Reliable and accurate measurement of the flow of a stream containing a mixture of the liquid and vapor states of the fluid is difficult using available process instrumentation. The non-homogenous composition of two-phase mixtures and their unpredictable and variable flow regimes makes stable flow regulation difficult using control valves.

Conventionally, the problems of both measuring and controlling two-phase flow are somewhat remediated by using either pumps, vaporizers, or both. Pumps have been used to increase the pressure of the stored fluid above its saturation pressure so that a purely liquid flow stream is assured by virtue of the fluid being in a condition below the saturation curve. Vaporizers have been used to increase the temperature of the stored fluid above its saturation temperature so that a purely vapor flow stream is assured by virtue of the fluid being in a condition above the saturation curve.

Ammonia (NH₃) is the reagent used in SCR systems to break nitrous oxides (NO_{X}) down into benign nitrogen and water vapor. The reagent is delivered to the site as a liquid in undiluted (anhydrous) form. It must be transported and stored under pressure or it will vaporize at ambient temperatures. In such SCR systems, forwarding pumps and vaporizers are traditionally utilized to introduce anhydrous ammonia reagent to the reactor as a vapor. The flow of the ammonia reagent is typically measured and controlled in the vapor state. The ammonia vapor is usually diluted using ambient air or heated combustion air prior to injection into the SCR system. Dynegy Midwest Generation pioneered a system in which liquid ammonia is injected directly into a heated combustion air stream which vaporizes and dilutes the ammonia. That system requires pumps to increase the liquid ammonia pressure so that the ammonia flow is measured and controlled in a liquid state.

Yet without the pressure from those pumps, flow control of a direct injection and vaporization system is unstable due to the fluid conditions at the flow control valve. In ammonia systems, the two-phase mixture of ammonia liquid and vapor is not homogenous as it flows to the reactor. Instead it contains slugs of vapor which percolate through the piping, causing erratic ammonia flow measurement and control.

Two-phase flow simply cannot be assumed to consist of a homogeneous mixture of the vapor and liquid phases. A number of flow regimes are possible depending on the ratio of the phases, the velocity of each phase, their relative densities and viscosities, and the liquid surface tension. The flow regime also depends strongly on the vertical, horizontal, or inclined orientation of the piping, and whether the flow direction is up or down. Examples of some of the disadvantageous two-phase flow regimes are shown in FIG. 1. The slug flow pattern is particularly undesirable because the pulsating flow may cause excessive vibration and control instability.

Two-phase gas/liquid flow is common in the petrochemical industry and is a much-studied subject. Flow pattern maps have been developed for both horizontal flow and vertical up flow as tools to predict flow regimes and transitions. Yet, these maps are generally considered unreliable if applied outside the range of experimental data used in their creation. Since these maps were devised using mixtures of air and water or hydrocarbon mixtures, large errors may occur when applied to saturated ammonia mixtures, the focus of the present invention. Because of this, the flow regime is not known and may not be consistent. While closed loop flow control maintains the set point over a long-term average, short term fluctuations about the set point result in unsatisfactory system performance.

The piping configuration as shown in FIG. 2 is such that the two-phase flow conditions exist upstream of the flow control valve. The pressure drop across the flow control valve causes more of the ammonia to flash to vapor. Air is used to atomize the remaining liquid into small droplets in a dual fluid spray nozzle.

It would be beneficial for the ammonia to be homogenous at the flow element and at the control valve inlet port, in order to promote more stable flow measurement and control.

Therefore, there exists a need for a controlled-delivery system for metering an unstable mixture of liquid and vapor, in particular, a direct injection and vaporization of ammonia system for stable delivery of ammonia reagent to a SCR system.

### BRIEF SUMMARY OF INVENTION

Briefly described, in its preferred form, the present invention directs to a process to control the flow of anhydrous ammonia reagent to a SCR system that may be used to remove oxides of nitrogen (NO_{X}) from the flue gas, or to the control of the flow of fluid fuel to a combustor. These fluid fuels may include, without limitation, methane, butane, propane, liquefied natural gas, and other liquids that exist as a vapor at ambient temperature and pressure, but as a liquid at ambient temperatures and elevated pressure.

The present invention solves the conventional problems of measuring and controlling two-phase flow by separating the two-phase mixture into individual flow streams, each comprising nearly all or entirely of liquid, or of vapor. The flow of these individual liquid and vapor streams may then be separately measured and controlled.

In a preferred form, the present invention may introduce a separation chamber, such as, without limitation, a standpipe, into a delivery system, wherein the two-phase ammonia mixture flows into the standpipe and the ammonia liquid and vapor are separated with the resulting two steams of liquid and vapor then being subsequently easily and/or more accurately measured and controlled.

The present system may enable the entire fluid forwarding and flow control system to function on the saturation curve without the need for additional heat or pressure.

The invention improves on the prior art by allowing the liquid to flow from the storage vessel to the process under its own pressure (e.g., vapor pressure) without the need for forwarding pumps. A significant fraction of the liquid flashes to vapor due to static and dynamic pressure losses in the forwarding line. The liquid/vapor mixture is introduced into a separation chamber (standpipe) near the point of injection to the process, where it is separated into its liquid and vapor components, such as, without limitation, by using the force of gravity.

The two-phase liquid/vapor mixture flows into the standpipe where the denser liquid phase is segregated from the lighter vapor phase by gravity. The liquid flows from the bottom of the standpipe, forming a liquid column of sufficient height to overcome downstream dynamic losses and assure a substantially purely liquid state through the flow measurement device to the control valve. The liquid flows through the control valve and is then introduced to a hot gas stream for further vaporization and dilution, or is introduced directly into a SCR system.

The vapor flows from the top of the standpipe as a separate stream. The flow of the vapor stream may be controlled to maintain the desired liquid level in the standpipe and the desired pressure in the base of the liquid column. The flow of vapor may be measured directly or may be inferred by calculating the quality of the mixture. The vapor is introduced into the process by various means.

It is preferred for the ammonia to be in a single homogenous phase at the control valve inlet port, in order to promote more stable flow measurement and control. The piping modification of the present invention remedies known problems, by separating the liquid and vapor phases, and introducing them separately to the downstream process. This arrangement also provides sufficient ammonia liquid hold-up time to maintain steady flow conditions to the control valve. In various embodiments, it requires no moving parts and relies solely on gravity and on the ammonia vapor pressure.

Thus, an object of the invention is to make flow control of the mixture readily achievable in a safe and stable manner over a range of operating conditions.

These and other objects, features and advantages of the present invention will become more apparent upon reading the following specification in conjunction with the accompanying drawing figures.

### BRIEF DESCRIPTION OF THE DRAWINGS

These and other objects and features of this invention will be better understood from the following detailed description taken in conjunction with the drawings and attachments wherein:

FIG. 1a and FIG. 1b illustrate known issues with two-phase flow regimes.

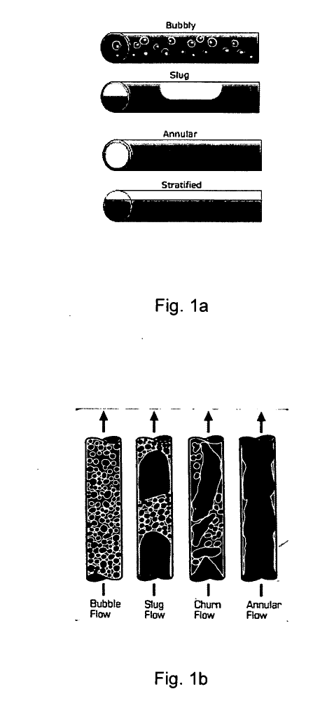

FIG. 2 illustrates a SCR system piping configuration, simplified for clarity.

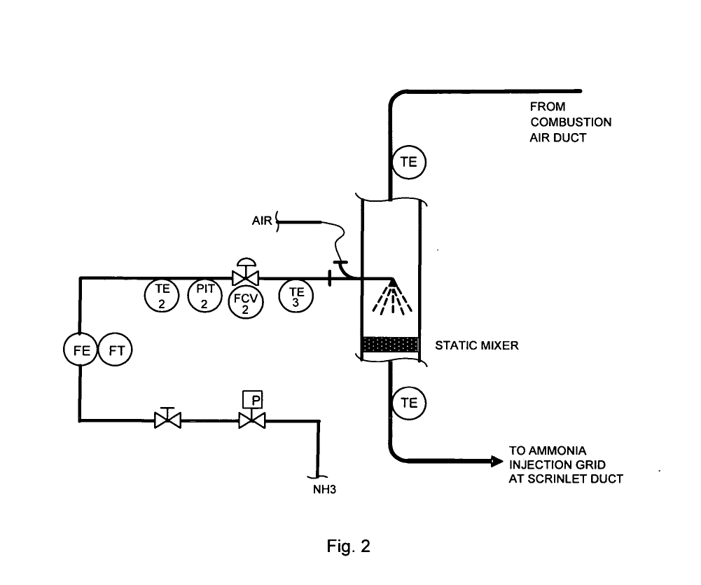

FIG. 3 illustrates a preferred embodiment of the present invention, with a SCR system piping configuration that has been modified, wherein the figure is simplified for clarity.

FIG. 4 illustrates another preferred embodiment of the present invention, wherein the process flow diagram shows the storage vessel, forwarding line, standpipe, control valves and instrumentation.

FIG. 5 illustrates another preferred embodiment of the present invention showing a cascaded level control loop.

FIG. 6 illustrates another preferred embodiment of the present invention showing a dual fluid spray nozzle.

FIG. 7 illustrates another preferred embodiment of the present invention, and set of equations by which the quality of the mixture is determined for use in the mass flow calculations.

FIG. 8 illustrates another preferred embodiment of the present invention showing a storage tank equipped with a heating device.

FIG. 9 shows a schematic diagram of an exemplary controlled-delivery process in accordance with one embodiment of the present invention.

Abbreviations used in the figures: flow element, FE; flow transmitter, FT; temperature element, TE; pressure indicating transmitter, PIT; flow indicating controller, FIC; flow control valve, FCV; level control valve, LCV; pressure control valve, PCV; pressure indicating controller, PIC; level transmitter, LT; level indicating controller, LIC; process variable, PV; controlled variable, CV; set point, SP; flow relay, FY; and pneumatic valve actuator, P.

### DETAILED DESCRIPTION OF PREFERRED EMBODIMENTS

The present invention broadly pertains to the control of the flow of fluids with thermodynamic properties, preferably similar to ammonia and other refrigerants, which are stored as a liquid under pressure and delivered to a process as a vapor or as a mixture of liquid and vapor. A substance that exists as a vapor at ambient temperature and pressure, but exists as a liquid at ambient temperature and elevated pressure, will exist as a saturated mixture of liquid and vapor at any point on the saturation curve pertaining to the substance.

When liquid at the saturation temperature and pressure undergoes static and/or dynamic pressure loss as it flows in a pipe, a fraction of the liquid flashes to vapor in the pipe. The flow of the resulting two-phase mixture of liquid and vapor is difficult to measure and control.

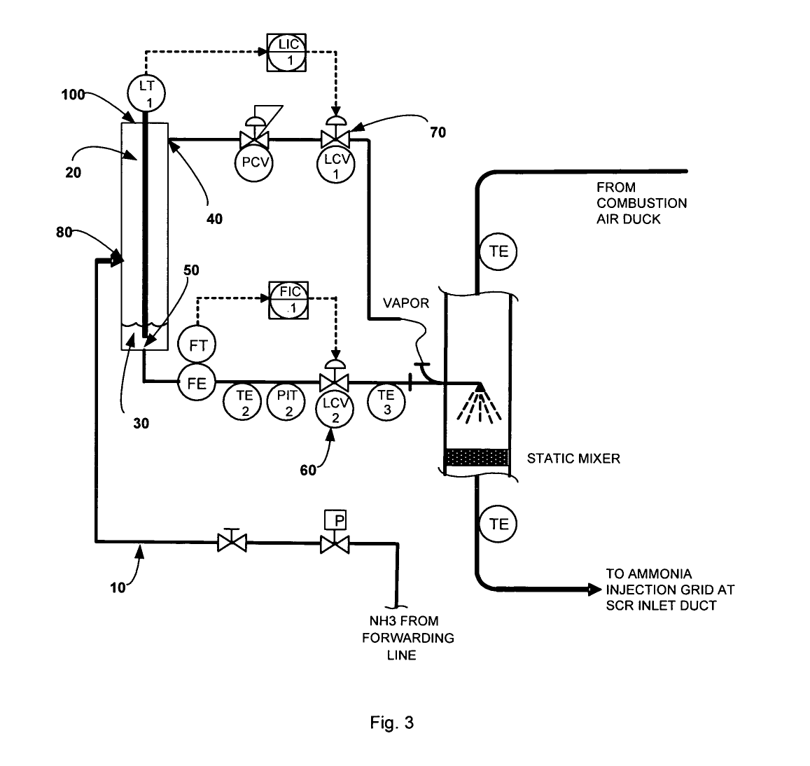

Referring now in detail to the drawing figures, wherein like references represent like parts throughout the several views, FIG. 3 illustrates a preferred embodiment of the present invention, where the two-phase ammonia mixture flows into the standpipe 100 through feed conduit 10 and inlet 80, where the liquid 30 accumulates at the bottom and the vapor 20 at the top. The liquid 30 and vapor 20 are piped separately to the respective outlets 50 and 40 to the dual fluid atomizing injection nozzle. The liquid flow may be regulated by a flow control valve 60, as most of the mass flow is in the liquid stream. The vapor flow may be regulated using a level control valve 70 to control the liquid level in the standpipe 100.

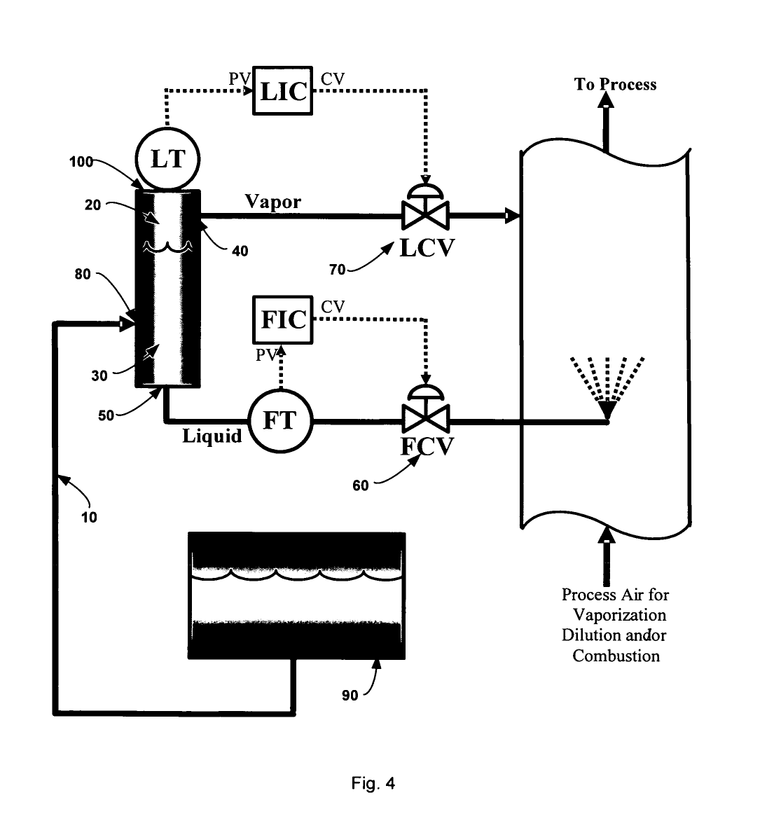

As shown in FIG. 4, in another preferred embodiment, the present invention is a method for controlling the flow of such a two-phase mixture of a liquid and its vapor, by introducing the mixture into a separation chamber 100, or standpipe, in which the force of gravity separates the liquid 30 and vapor 20 components according to their densities, and then regulating the flow of each component via separate outlets 50 and 40 from the standpipe 100.

In some designs, the liquid outlet 50 may be from the bottom of the standpipe 100 (where the liquid collects), and the column of liquid 30 in the standpipe 100 and its liquid outlet 50 may be of sufficient height to produce, at the bottom of the column, a static pressure sufficient to preclude vapor formation (flashing) in the flow measurement device and other devices upstream of the flow control device 60 due to the pressure loss across the devices, i.e., the height of the liquid column multiplied by the liquid density and the acceleration of gravity (ρgh) is greater than the dynamic pressure loss resulting from the flow of the liquid 30 from the standpipe 100 and through the devices upstream of the flow control device 60.

The control algorithm for the embodiment of FIG. 4 may include both continuously measuring the flow of liquid 30 from the standpipe 100, and controlling the flow according to the demand from a downstream process using a flow control valve 60. The flow of vapor 20 from the standpipe 100 preferably also is regulated to control the liquid level in the standpipe 100 by means of continuous measurement of the liquid level in the standpipe 100, an automatic control valve 70 downstream from the vapor outlet 40, and a feedback control loop.

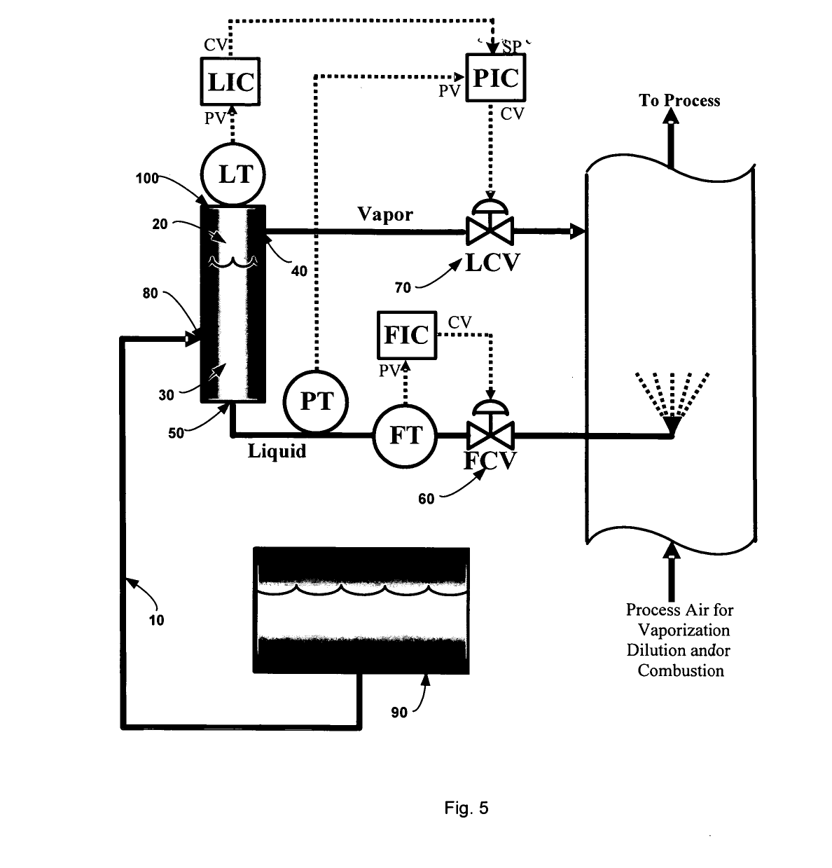

In another embodiment, as shown in FIG. 5, the control algorithm may include a cascaded control loop utilizing a plurality of control parameters, such as, a pressure at or near the inlet 80 or the liquid outlet 50. This preferred embodiment of the present invention has been demonstrated to provide more stable performance in some cases. The pressure at or near the inlet 80 may be calculated using the pressure in the storage tank 90 minus the pressure loss between the tank 90 and the standpipe 100. The pressure of the tank 90 may be regulated using various standard techniques known in the art, such as, without limitation, adjusting the temperature of the composition/liquid in the tank 90. The pressure loss between the tank 90 and the standpipe 100 may primarily be the result of the difference in elevation of the two vessels. In one embodiment of the present invention, the standpipe 100 may be located above the storage tank 90 so there is a static pressure difference (ρgh) between them. There is also some frictional pressure loss, although it may be negligible under various operating conditions.

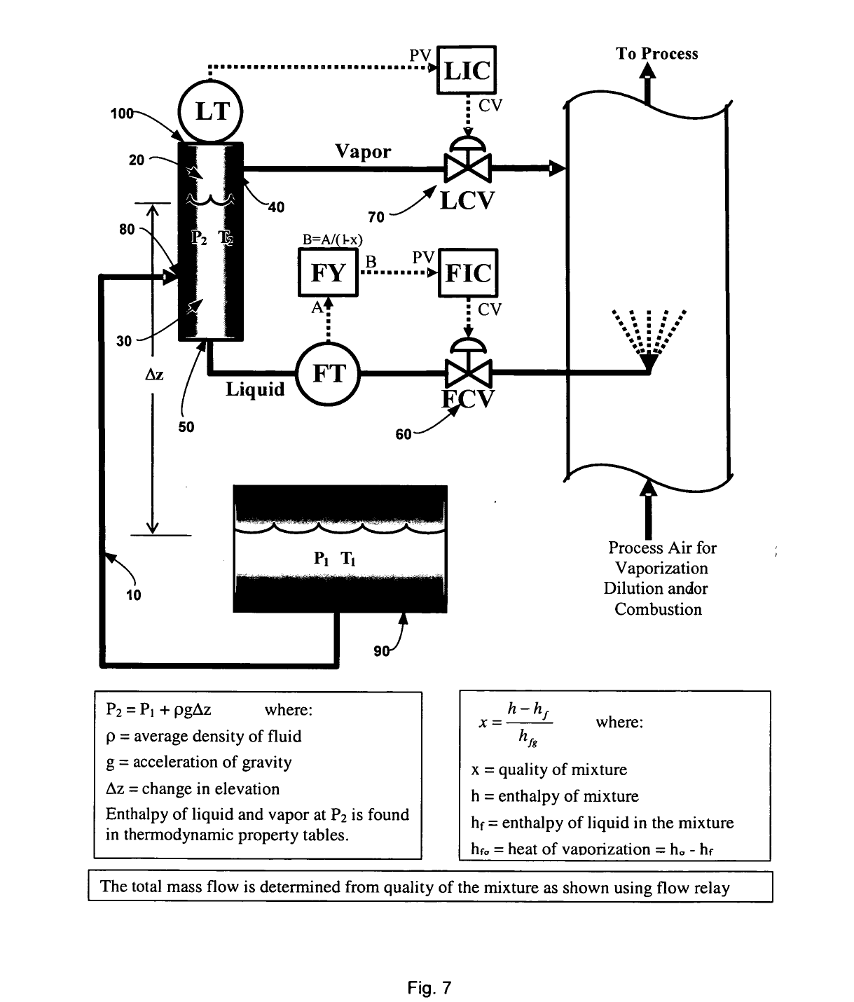

In another embodiment, the control algorithm can be enhanced to provide more accurate mass flow control by calculating the weight percent vapor, or quality, of the mixture entering the standpipe. The quality of the mixture is determined from the initial pressure of the fluid in the storage vessel and the difference in elevation between the liquid levels in the storage vessel 90 and in the standpipe 100. Equations of FIG. 7 are solved for the initial pressure and the level difference at which the process operates. The resulting quality is used to infer the total mass flow of liquid and vapor from the measured liquid flow.

The quality of the mixture depends primarily or only on two variables, the initial temperature of the liquid (e.g., ammonia) at the storage tank 90, and the difference in pressure between the storage tank 90 and the separation chamber 100. The temperature fluctuates slowly within the ambient range, which is known and finite. The pressure difference is primarily due to the elevation change between the liquid level in the tank 90 and in the standpipe 30, which also varies slowly within a known and finite range. The dynamic losses in pressure due to frictional flow are often small enough to be neglected.

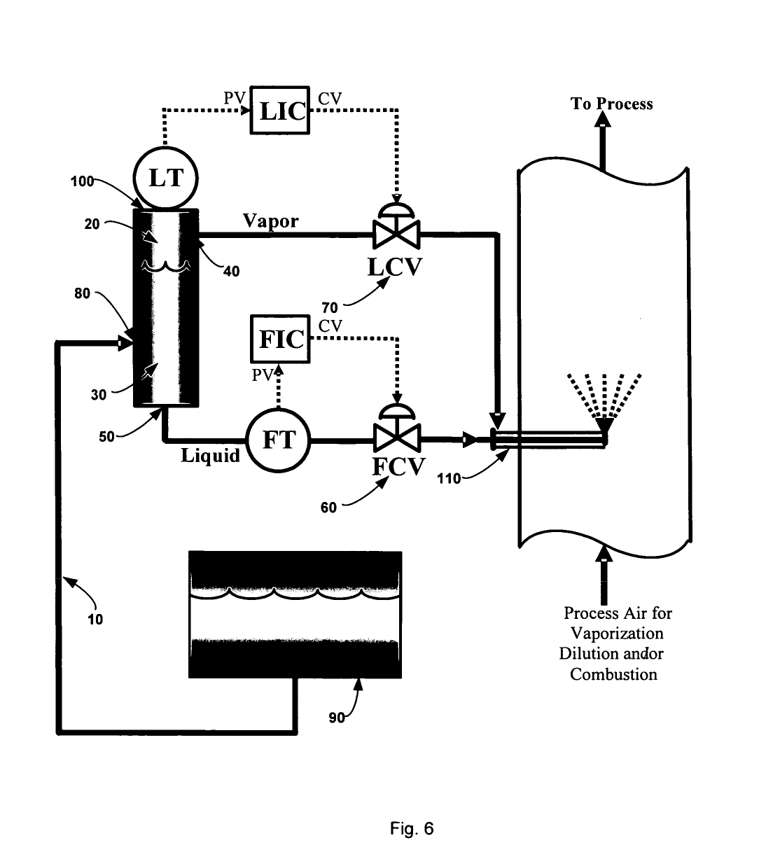

In yet another preferred embodiment, as shown in FIG. 6, the liquid and vapor streams are recombined downstream of the separate flow regulating devices using a collection means 110 (e.g., a dual fluid spray nozzle) to introduce the mixture to a process. The vapor is used to atomize the remaining liquid exiting the dual fluid nozzle to promote complete vaporization in the process.

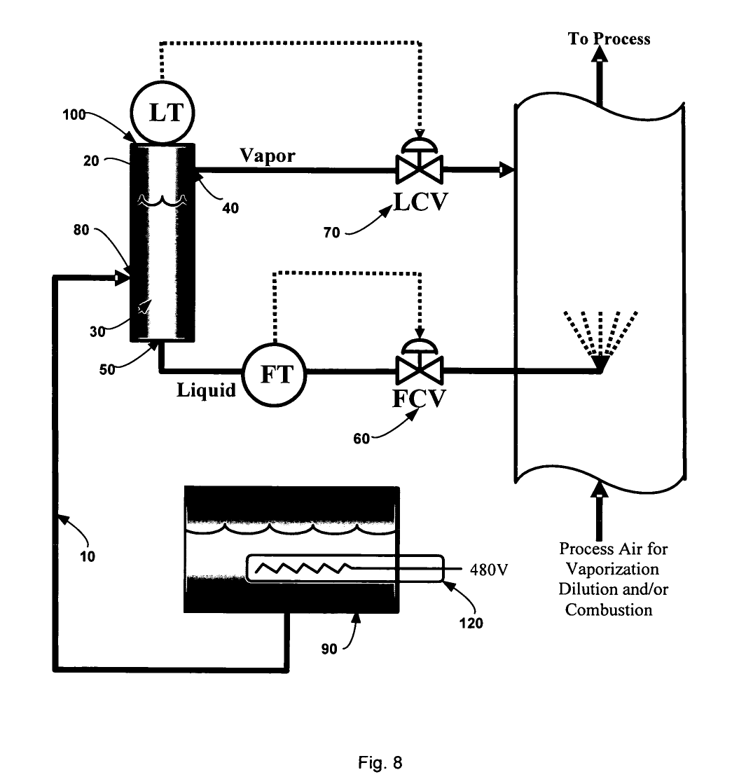

In various embodiments of the present invention, such as, without limitation, when omitting the use of forward pumps from the system, or when the ambient temperature is low, as illustrated in FIG. 8, it is desirable to maintain the internal pressure of the storage tank 90 and/or the temperature/pressure of the liquid or the liquid and vapor mixture in the storage tank to be above a minimum threshold, such as, a minimum pressure (e.g., about 45 psig) to overcome the static pressure difference between the storage tank 90 and the standpipe 100 to allow the liquid flow from the tank 90 to the standpipe 100, or a minimum temperature of about 30° F. Techniques for maintaining or increasing the internal pressure of a storage tank 90 and the temperature/pressure of the liquid or the liquid and vapor mixture in the storage tank 90 are well known in the art. For example, a storage tank 90 may be equipped with a heater 120, where the internal pressure of the tank 90 or the pressure of the liquid stored in the tank may be raised by increasing the temperature of the tank 90 and/or the liquid by the operation of the heater 120. In one embodiment, the temperature of the liquid may be maintained using a heater to be above about 30° F. Limiting the lower end of the pressure and temperature range may have the benefits of significantly enlarging the pool of suitable control valves and reducing the cost of the system.

The standpipe 100 preferably is sized for the two-phase flow conditions, which are bracketed or bounded by the limited range of temperature and differential pressure. In one example, it can be shown that the quality varies between about 1.2% and about 2.3% vapor by weight, which corresponds to a range of about 40% to about 85% vapor by volume. The separation chamber 100 is sized for a liquid residence time sufficient to smooth out the pulsations in liquid flow, and provide a steady liquid flow condition to the control valve 60.

The liquid flow measurement is about 98% to about 99% of the total mass flow, and the vapor flow can often be neglected for the purpose of flow control. Such a large liquid fraction enables the flow meter to be operatively located in the liquid line immediately downstream of the standpipe 100.

The liquid state enables a less costly type of flow meter be used. The standpipe 100 preferably should be located above the flow meter and the flow control valve 60, more preferably several feet above them, to provide enough static pressure to offset any dynamic losses through the piping.

The vapor flow may be regulated in proportion to the liquid flow based on the quality of the mixture. If the vapor flow is too great, the lost vapor volume will be replaced by the incoming mixture of liquid and vapor, causing the liquid level to rise. Conversely, the liquid level will fall if the vapor out-flow is too small in proportion to the liquid out-flow.

Rather than attempt to regulate the vapor flow in proportion to the liquid flow, in one embodiment, only vapor flow is regulated to maintain the proper liquid level in the standpipe 100. The level set point may correspond to the quality of the mixture, which may be calculated in the control system.

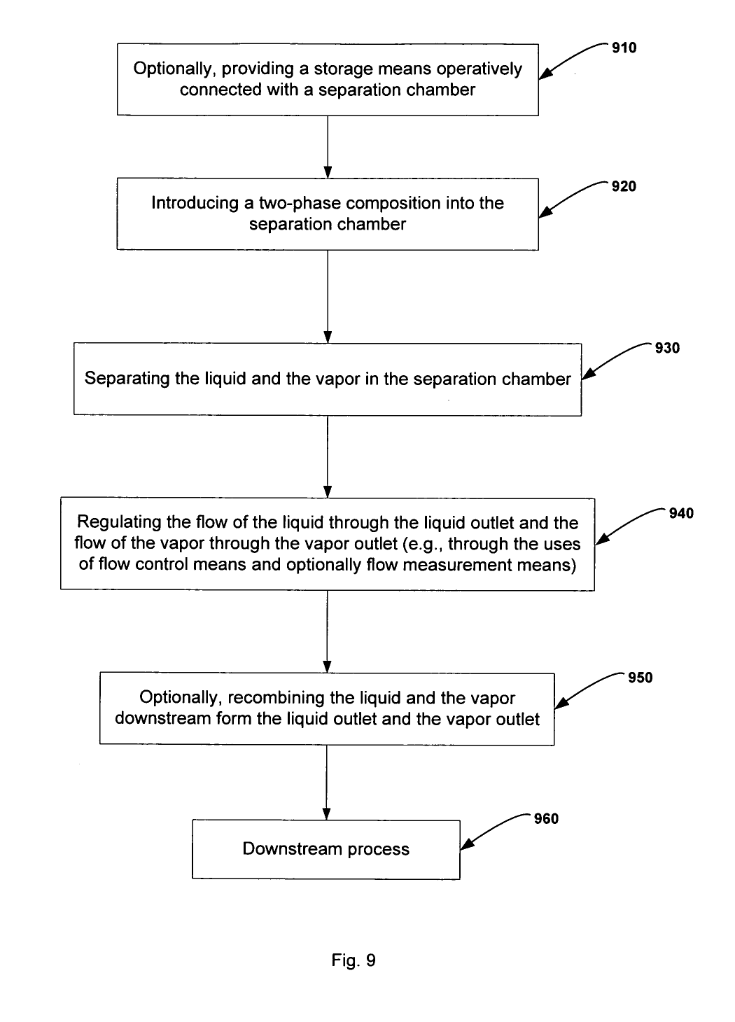

In one aspect, the present invention provides a method for regulating the flow of a two-phase composition containing a liquid and a vapor, which includes: introducing the two-phase composition into a separation chamber, where the separation chamber contains an inlet, a liquid outlet, a vapor outlet, and a pressure substantially above atmospheric pressure; separating the liquid and the vapor in the separation chamber; and regulating the flow of the liquid through the liquid outlet and the flow of the vapor through the vapor outlet. FIG. 9 shows an exemplary schematic diagram of the method in accordance with one embodiment of the present invention. In various embodiments of the present invention, the term “a pressure substantially above atmospheric pressure,” as used herein, includes a pressure which maintains the two-phase composition on its saturation curve.

In one embodiment, the method of the present invention may further include a step of providing a flow control means operatively connected with the liquid outlet or the vapor outlet. In another embodiment of the present invention, the method may further include providing a flow measurement means operatively located between the flow control means and the liquid outlet or the vapor outlet.

In various embodiments of the present invention, the liquid in the separation chamber may contain a pressure sufficient to prevent the formation of substantial amount of vapor between the liquid outlet and the flow control means. The pressure, for example, may be regulated at least partially through regulating the height of the liquid over the liquid outlet or the flow control means.

The flow of the liquid through the liquid outlet may be regulated at least partially through regulating the liquid level in the separation chamber. In one embodiment, the liquid level in the separation chamber may be regulated at least partially through operatively connecting a flow control means with the vapor outlet. In another embodiment, the operation of the flow control means may be regulated at least partially through using a feedback control system. The feedback control system may utilize a plurality of flow controlling parameters, including, without limitation, a liquid level in the separation chamber, a pressure at or near the liquid outlet, a pressure at or near the inlet, a quality of the two-phase composition, or combinations thereof. In yet another embodiment, the.flow of the liquid through the liquid outlet may be regulated at least partially through regulating the flow control means using a demand parameter from a downstream process.

The liquid and the vapor streams downstream from the liquid outlet and the vapor outlet may be recombined. In one embodiment of the present invention, the recombined liquid and vapor may be vaporized, where at least a portion of the liquid becomes liquid droplets. In another embodiment, the method of the present invention may further include a step of providing a feed conduit operatively connected with the inlet, where the size of the feed conduit is sufficient to facilitate the formation of a substantially uniform mass flow of a mixture of the liquid droplets and vapor into the separation chamber.

In addition, the method of the present invention may further include providing a storage means operatively connected with the inlet, wherein the storage means may contain a heating means and the two-phase composition or the liquid, and where the internal pressure of the storage means or the temperature of the two-phase composition or the liquid may be raised through heating the storage tank or the two-phase composition or the liquid using the heating means.

In another aspect, the present invention provides a system for regulating the flow of a two-phase composition containing a liquid and a vapor, which includes, without limitation, a feed conduit, a separation chamber, and a flow control means, where:
the separation chamber contains an inlet, a liquid outlet, a vapor outlet, and a pressure substantially above atmospheric pressure;
the feed conduit is operatively connected with the inlet;
the flow control means is operatively connected with the liquid outlet or the vapor outlet;
the feed conduit introduces the two-phase composition into the separation chamber through the inlet;
the separation chamber facilitates the separation of the liquid and the vapor; and
the flow control means regulates the flow of the liquid through the liquid outlet or the flow of the vapor through the vapor outlet.

In one embodiment of the present invention, the system may further contain a flow measurement means operatively located between the flow control means and the liquid outlet or the vapor outlet. In another embodiment, the system may further include a pressure controlling means for regulating the pressure of the liquid in the separation chamber, where the pressure is sufficient to prevent the formation of substantial amount of vapor between the liquid outlet and the flow control means. For example, the pressure of the liquid may be regulated at least partially through regulating the height of the liquid over the liquid outlet or the flow control means.

In various embodiments of the present invention, the system may further contain a collection means for recombining the liquid and the vapor downstream from the liquid outlet and the vapor outlet. The system may also include a vaporization means for vaporizing the recombined liquid and vapor, where at least a portion of the liquid becomes liquid droplets. In one embodiment, the size of the feed conduit may be sufficient to facilitate the formation of a substantially uniform mass flow of a mixture of the liquid droplets and vapor into the separation chamber.

In addition, the system of present invention may further include a storage means operatively connected with the feed conduit, where the storage means may contain a heating means and the two-phase composition or the liquid, and where the internal pressure of the storage means or the temperature of the two-phase composition or the liquid may be raised through the operation of the heating means.

While the invention has been disclosed in its preferred forms, it will be apparent to those skilled in the art that many modifications, additions, and deletions can be made therein without departing from the spirit and scope of the invention and its equivalents as set forth in the following claims.

I claim:

1. A method for regulating the flow of a two-phase composition comprising a liquid and a vapor, comprising:
introducing a two-phase composition into a separation chamber, wherein the separation chamber comprises an inlet, a liquid outlet, a vapor outlet, and a pressure substantially above atmospheric pressure;
separating the liquid and the vapor in the separation chamber; and
regulating the flow of the liquid through the liquid outlet and the flow of the vapor through the vapor outlet.

2. The method of claim 1, further comprising providing a flow control means operatively connected with the liquid outlet or the vapor outlet.

3. The method of claim 2, further comprising providing a flow measurement means operatively located between the flow control means and the liquid outlet or the vapor outlet.

4. The method of claim 2, wherein the liquid in the separation chamber comprises a pressure sufficient to prevent the formation of substantial amount of vapor between the liquid outlet and the flow control means.

5. The method of claim 4, wherein the pressure is regulated at least partially through regulating the height of the liquid over the liquid outlet or the flow control means.

6. The method of claim 2, wherein the flow of the liquid through the liquid outlet is regulated at least partially through regulating the liquid level in the separation chamber.

7. The method of claim 6, wherein the liquid level in the separation chamber is regulated at least partially through operatively connecting a flow control means with the vapor outlet.

8. The method of claim 7, wherein the operation of the flow control means is regulated at least partially through using a feedback control system, wherein the feedback control system utilizes a plurality of flow controlling parameters, and wherein the plurality of flow controlling parameters comprises a liquid level in the separation chamber, a pressure at or near the liquid outlet, a pressure at or near the inlet, or a quality of the two-phase composition.

9. The method of claim 2, wherein the flow of the liquid through the liquid outlet is regulated at least partially through regulating the flow control means using a demand parameter from a downstream process.

10. The method of claim 1, wherein the liquid and the vapor are recombined downstream from the liquid outlet and the vapor outlet.

11. The method of claim 10, wherein the recombined liquid and vapor is vaporized, wherein at least a portion of the liquid becomes liquid droplets.

12. The method of claim 1, further comprising providing a feed conduit operatively connected with the inlet, wherein the size of the feed conduit is sufficient to facilitate the formation of a substantially uniform mass flow of a mixture of the liquid droplets and vapor into the separation chamber.

13. The method of claim 1, further comprising providing a storage means operatively connected with the inlet, wherein the storage means comprises a heating means and the two-phase composition or the liquid, and wherein the internal pressure of the storage means or the temperature of the two-phase composition or the liquid is raised through the heating means.

14. The method of claim 1, wherein the two-phase composition comprises ammonia.

15. A system for regulating the flow of a two-phase composition comprising a liquid and a vapor, comprising a feed conduit, a separation chamber, and a flow control means, wherein:
the separation chamber comprises an inlet, a liquid outlet, a vapor outlet, and a pressure substantially above atmospheric pressure;
the feed conduit is operatively connected with the inlet;
the flow control means is operatively connected with the liquid outlet or the vapor outlet;
the feed conduit introduces the two-phase composition into the separation chamber through the inlet;
the separation chamber facilitates the separation of the liquid and the vapor; and
the flow control means regulates the flow of the liquid through the liquid outlet or the flow of the vapor through the vapor outlet.

16. The system of claim 15, further comprising a flow measurement means operatively located between the flow control means and the liquid outlet or the vapor outlet.

17. The system of claim 15, further comprising a pressure controlling means for regulating the pressure of the liquid in the separation chamber, wherein the pressure is sufficient to prevent the formation of substantial amount of vapor between the liquid outlet and the flow control means.

18. The system of claim 15, wherein the flow of the liquid through the liquid outlet is regulated at least partially through regulating the liquid level in the separation chamber.

19. The system of claim 18, wherein the liquid level in the separation chamber is regulated at least partially through operatively connecting a flow control means with the vapor outlet.

20. The system of claim 19, wherein the operation of the flow control means is regulated at least partially through a feedback control system, wherein the feedback control system utilizes a plurality of flow controlling parameters, and wherein the plurality of flow controlling parameters comprises a liquid level in the separation chamber, a pressure at or near the liquid outlet, a pressure at or near the inlet, or a quality of the two-phase composition.

21. The system of claim 15, further comprising a downstream demand feedback means for regulating the flow of the liquid through the liquid outlet, wherein the downstream demand feedback means utilizes a demand parameter from a downstream process.

22. The system of claim 15, further comprising a collection means for recombining the liquid and the vapor downstream from the liquid outlet and the vapor outlet.

23. The system of claim 22, further comprising a vaporization means for vaporizing the recombined liquid and vapor, wherein at least a portion of the liquid becomes liquid droplets.

24. The system of claim 15, further comprising a storage means operatively connected with the feed conduit, wherein the storage means comprises a heating means and the two-phase composition or the liquid, and wherein the internal pressure of the storage means or the temperature of the two-phase composition or the liquid is raised through the heating means.
